(19) United States
(12) Patent Application Publication
(10) Pub. No.: US 2012/0274037 A1
(43) Pub. Date: Nov. 1, 2012

(54) COMPRESSIBLE WHEEL TIP FOR A WALKING AID

(75) Inventor: F. Troy Miller, Logan, UT (US)

(73) Assignee: STANDER, INC., Logan, UT (US)

(21) Appl. No.: 13/284,126

(22) Filed: Oct. 28, 2011

Related U.S. Application Data
(63) Continuation of application No. 12/605,817, filed on Oct. 26, 2009, now abandoned.

(51) Int. Cl. B60B 33/00; A61H 3/04

(52) U.S. Cl. 280/87.041; 16/45

(57) ABSTRACT

A compressible wheel tip for a walking aid that restricts rolling when a force is applied down on the walking aid. The tip may have a compressible wheel configured to deform under an applied pressure and thereby restrict shifting or rolling of the wheel. The compressible wheel may include rigid spokes and a compressible material forming an arcuate perimeter between the spokes to define a wheel shape. The compressible material may be a resilient elastomeric material adapted to deform under an applied force and return to its original shape when the force is no longer applied. The spokes may be formed of plastic or metal, or formed of the same material as the spokes and structured to better resist deformation.

### CROSS-REFERENCE TO RELATED APPLICATIONS

This patent application is a continuation of now pending U.S. patent application Ser. No. 12/605,817, entitled COMPRESSIBLE WHEEL TIP FOR A WALKING AID, filed on Oct. 26, 2009, which is fully incorporated by reference herein.

### TECHNICAL FIELD

The present disclosure relates generally to walking aids. More specifically, the present disclosure relates to walking aids, such as walkers, having an optionally removable tip with a compressible wheel configured to roll when little or no downward pressure is applied to it and capable of compressing to restrict rolling when sufficient downward pressure is applied.

### BRIEF DESCRIPTION OF THE DRAWINGS

The embodiments disclosed herein will become more fully apparent from the following description and appended claims, taken in conjunction with the accompanying drawings. These drawings depict only typical embodiments, which will be described with additional specificity and detail through use of the accompanying drawings in which:

FIG. 1 is a perspective view of one embodiment of a walking aid, specifically a walker, having one or more compressible wheel tip(s).

FIG. 2A is a side elevation view of one embodiment of a compressible wheel tip in an uncompressed state and attached to a shaft of a walking aid.

FIG. 2B is a side elevation view of one embodiment of a compressible wheel tip attached to a shaft of a walking aid, the wheel of the compressible wheel tip compressed due to force applied down the shaft of the walking aid.

FIG. 3A is a front elevation view of one embodiment of a compressible wheel tip in an uncompressed state and attached to a shaft of a walking aid.

FIG. 3B is a front elevation view of one embodiment of a compressible wheel tip attached to a shaft of a walking aid, the wheel of the compressible wheel tip compressed due to force applied down the shaft of the walking aid.

FIG. 4 is a exploded perspective view of one embodiment of a compressible wheel tip and a shaft of a walking aid.

FIG. 5 is a perspective view of one embodiment of a compressible wheel.

FIG. 6 is a front elevation view of the compressible wheel of FIG. 5.

FIG. 7 is a front cross-sectional view of the compressible wheel of FIG. 5.

FIG. 8 is a side elevation view of the compressible wheel of FIG. 5 attached to a shaft of a walking aid, the wheel compressed due to force applied down the shaft of the walking aid.

FIG. 9A is a side elevation view of another embodiment of a compressible wheel in an uncompressed state.

FIG. 9B is a side elevation view of the compressible wheel of FIG. 9A in a compressed state.

FIG. 10 is a perspective view of another embodiment of a compressible wheel.

### DETAILED DESCRIPTION

Certain individuals may require the assistance of a walking aid, such as a walker, to be able to walk on their own. A walker may provide greater support and stability than other walking aids because it typically has a plurality of contact points with the ground. The plurality of contact points provide a firm base upon which a user of the walker can lean or apply pressure to steady himself. The plurality of contact points with the ground are generally shafts extending from one or more handles to a tip in contact with the ground.

A disadvantage of some conventional walkers is that they may be heavier than other walking aids, such as a simple cane, and thus the user may have difficulty advancing it as he walks. Conventionally, this problem has been addressed by placing a wheeled tip on one or more of the plurality of shafts. A wheel, however, inherently decreases stability because it may roll, causing the walking aid to move or shift and thereby create an unstable base for the user to lean on to steady himself. The present disclosure addresses this issue by providing a compressible wheel that partially collapses and will not roll when the user leans, rests his weight, or otherwise applies a force down the shaft of the walker.

It will be readily understood that the components of the embodiments as generally described and illustrated in the Figures herein could be arranged and designed in a wide variety of different configurations. Thus, the following more detailed description of various embodiments, as represented in the Figures, is not intended to limit the scope of the invention, as claimed, but is merely representative of various embodiments. While the various aspects of the embodiments are presented in drawings, the drawings are not necessarily drawn to scale unless specifically indicated.

The phrases “connected to,” “coupled to” and “in communication with” refer to any form of interaction between two or more entities, including mechanical, electrical, magnetic, electromagnetic, fluid, and thermal interaction. Two components may be coupled to each other even though they are not in direct contact with each other. For example, two components may be coupled to each other through an intermediate component.

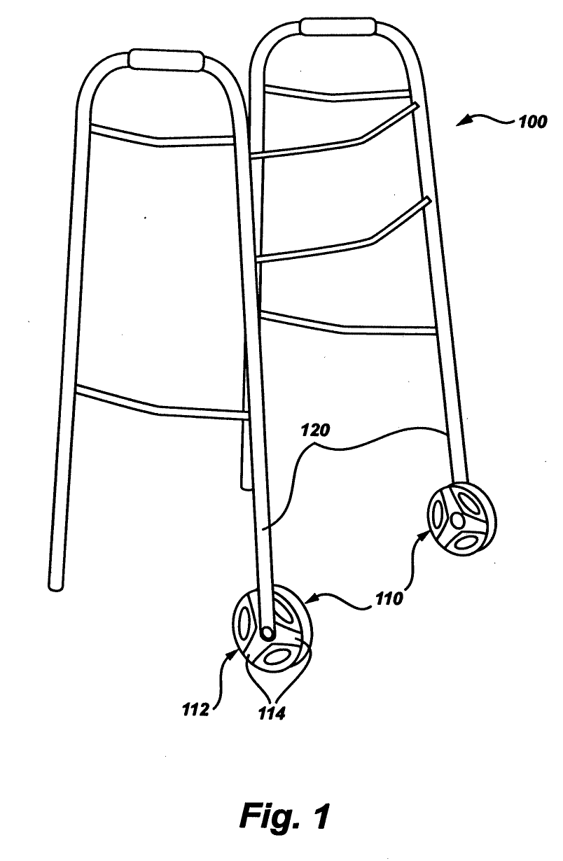

FIG. 1 shows a perspective view of one embodiment of a walking aid 100, specifically a walker, having compressible wheel tips 110 coupled to two of the leg shafts 120 of the walker. In another embodiment, all four leg shafts may be coupled to compressible wheel tips. In still another embodiment, other numbers of leg shafts may be coupled to compressible wheel tips.

A user generally uses the walker to support his weight. The user may use the walker simply to aid in standing, or may use the walker to aid in walking. Generally the user can support his weight sufficiently to advance the walker forward a short distance. With the walker advanced, the user may then lean, or otherwise support his weight on the walker, thereby aiding the user to take one or more steps.

Wheels 112 on the legs 120 of the walker 100 facilitate advancing the walker 100 by reducing the friction of the tips of the legs 120, thus enabling the user to simply push the walker 100 forward. Without the wheel tips 110, the tips of the walker legs 120 may not easily slide on the surface of the ground and the user may need to pick up the walker 100 to advance it.

With wheeled tips on a walker there is a risk that the wheels may roll causing the walker to shift. If a walker shifts or moves while a user is leaning on or supporting his weight on the walker, the user may lose his balance and fall. In the embodiment shown in FIG. 1, the compressible wheel 112 of each of the tips 110 may compress and deform when force is applied down the leg shaft 120 of the walker 100. The compressible wheel 112 may further comprise rigid spokes 114 that may guide the deformation of the wheel 112 and thereby restrict the wheel 112 from rolling so as to provide a stable base. With the wheels 112 restricted from rolling and the walker 100 held firmly in place, the user may safely support his weight on, or lean against, the walker 100.

Inherently, during use of the walker 100 there may be some minimal downward force always being applied by the user to the walker 100 and, thus, also applied to the compressible wheel tip 110. However, the compressible wheel 112 may be configured to not compress when only a minimal downward force is applied. The user may apply a downward force sufficient to overcome the compressible wheel 112, such that it compresses, deforms, and does not roll.

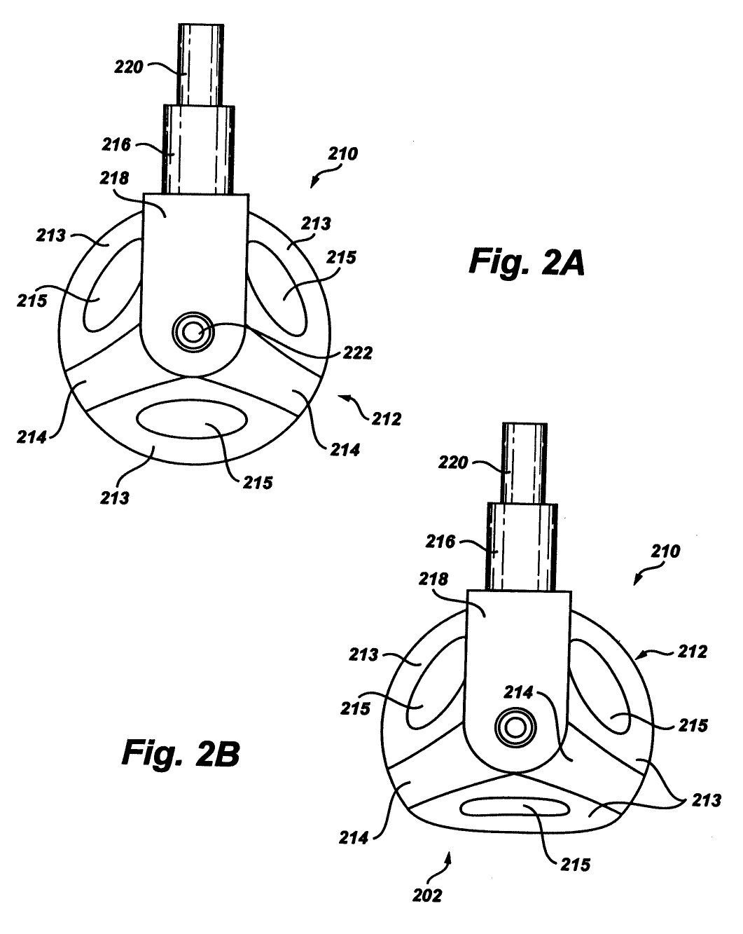

FIG. 2A is a side elevation view of one embodiment of a compressible wheel tip 210 in an uncompressed state and attached to a leg shaft 220 of a walking aid. The compressible wheel tip 210 may comprise a shaft engaging portion 216, a wheel coupling portion 218, and a compressible wheel 212 having a plurality of spokes 214 and a compressible material 213 between, or spanning an arc between, the spokes 214. The shaft-engaging portion 216 can be a bolt, bracket, or any component capable of coupling the compressible wheel 212 to the shaft of a walker, rollator, or other walking aid device. The shaft engaging portion 216 and the wheel coupling portion 218 may be one piece, or they may be separate parts coupled together. The compressible wheel 212 may be coupled to the wheel coupling portion 218 by an axle 222 extending through the center of the compressible wheel 212 to the wheel coupling portion 218, enabling the compressible wheel 212 to freely rotate about the axle 222.

In the embodiment shown, the compressible wheel 212 has three spokes 214. The spokes 214 may be formed of a rigid material, such as plastic or metal, so as to not deform with applied pressure. The spokes 214 may be joined together in the center of the compressible wheel 212. The spokes 214 are also shown as extending to the outer perimeter of the compressible wheel 212. As is evident, without the compressible material 213 between the spokes 214, the configuration of the spokes 214 is such that it will not roll. Rather, the spoke configuration will roll until two spokes 214 contact the ground or other surface, at which at least two of the spokes 214 would rest firmly on the ground and restrict continued rolling.

As depicted in FIG. 2A, the compressible material 213 may be positioned entirely between the spokes 214, such that there are three separate portions of compressible material, one in each of the three areas between the three spokes. The compressible material 213 of the depicted embodiment fills the area between the spokes 214, forming an arcuate perimeter between the spokes that, when not compressed, gives the compressible wheel 212 a round shape. The compressible material may comprise a resilient, elastomeric material adapted to deform with applied force and to return to its original shape when the force is removed or sufficiently minimized. Optionally, the compressible material may also be a thermoplastic material. When a force is applied down the shaft 204, the compressible material 213 in contact with the ground or other surface compresses and deforms between the spokes 214, thereby exposing the spokes to rest firmly on the ground and restrict rolling.

The compressible material 213, as depicted in FIG. 2A, may optimally define a void 215 to further aid in compressibility. In another embodiment, the compressible material 213 may not define a void. In still another embodiment, the compressible material 213 may define more than one void, the voids configured to aid in compressibility and deformation of the compressible material 213. Compression of the compressible material deforms the shape of the compressible wheel 212, allowing at least two of the spokes 214 to engage the ground simultaneously. When two spokes rest firmly against the ground, they are configured to restrict the wheel from shifting and rolling.

FIG. 2B is a side elevation view of the embodiment of FIG. 2A, wherein the wheel 212 of the compressible wheel tip 210 is compressed due to force applied down the shaft 220 of the walking aid. As depicted, the compressible material 213 may deform due to the force applied down the shaft 220 of the walking aid, enabling the wheel 212 to compress and restrict the wheel 212 from rolling. The compressible material 213 compresses causing the arc between two spokes 214 to flatten. The wheel 212 no longer presents a round surface with a single point of contact with the ground. Rather, the two spokes 214 provide two points of contact, presenting a flattened surface 202 or configuration that restricts rolling and shifting of the wheel. FIGS. 2A and 2B also depict what happens if a single spoke 214 is in line with the force down the shaft. The wheel 212 may roll or shift only until two spokes 214 are in contact with the ground, at which point the two points of contact restrict any further rolling and shifting.

A void 215 in the compressible material may further aid in compressibility. The compressible material 213 spanning the arc between the spokes 214 may collapse into the void 215 resulting in substantial deformation of the compressible wheel 212. The wheel spokes 214 may guide deformation. Moreover, the wheel spokes 214 may be formed of a material more rigid than the compressible material 213 and configured to provide a firm base that does not shift or roll when the compressible material 213 compresses and deforms to expose the spokes. The spokes 214 may be formed of any rigid material, including but not limited to rigid plastic or metal. In another embodiment, the spokes 214 may be formed of an elastomeric material that is more resilient than the compressible material 213. In still another embodiment, the spokes 214 and compressible material 213 are formed of the same material and structured such that the spokes 214 better resist deformation than the compressible material.

In another embodiment the compressible wheel may have a different spoke configuration with a different number of spokes. For example, configurations with a single spoke, two spokes, or more than three spokes are possible. The spokes may be coupled to a hub in the center of the compressible wheel. In still another embodiment, the spokes may extend only to an inner perimeter of a tire. The tire may be formed of a compressible material, extending around and between the spokes to give the compressible wheel a round shape when little or no pressure is applied and compressing between the spokes when pressure is applied.

In yet another embodiment, the compressible wheel may comprise a rigid hub, spokes formed of a compressible material, and an outer perimeter or rim of the wheel formed of material more rigid than the spokes. The compressible material of the spokes may comprise a resilient, elastomeric material adapted to deform with applied force and to return to its original shape when the force is removed or sufficiently minimized. When a force is applied down a shaft of a walking aid, the compressible material of the spokes stretches and/or compresses. The stretching and/or compressing of the spokes causes the axis of rotation of the wheel to no longer be concentric to the rim, thereby resulting in a braking action. In addition, stretching and/or compression of the spokes may allow the rigid outer rim to contact a wheel coupling portion of the compressible wheel. Contact of the rigid outer rim with the wheel coupling portion enables the wheel coupling portion to restrict movement and/or rolling of the compressible wheel, thereby producing a breaking action.

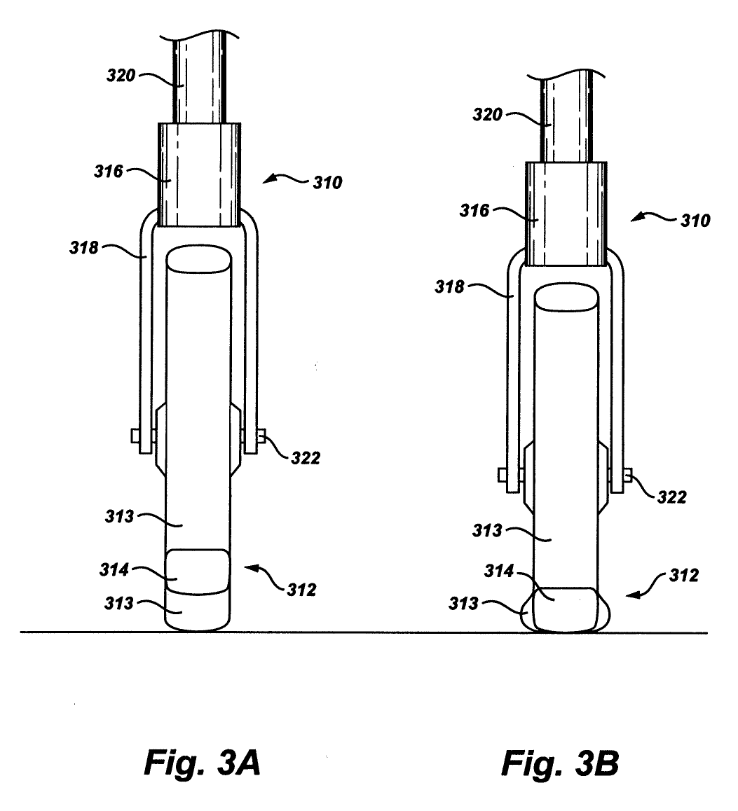

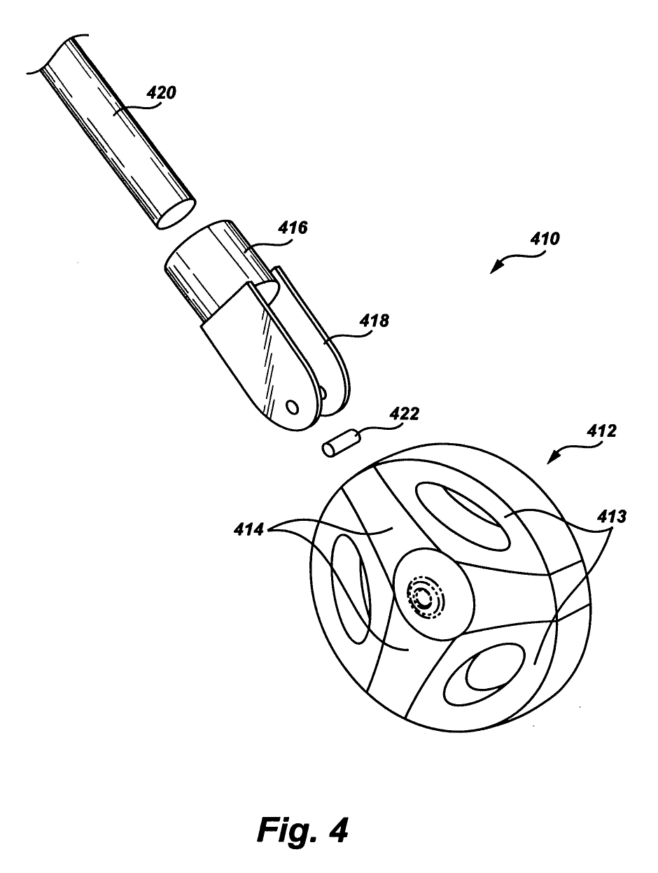

FIG. 3A is a front elevation view of one embodiment of a compressible wheel tip 310 in an uncompressed state attached to a shaft 320 of a walking aid. The compressible wheel tip 310 may comprise a shaft engaging portion 316, a wheel coupling portion 318, and a compressible wheel 312 having a plurality of spokes 314 and a compressible material 313 between the spokes. As depicted, the spokes 314 may extend to the perimeter of compressible wheel 312. In alternative embodiments, however, the spokes 314 may extend toward, but not reach, the perimeter of the compressible wheel 312. The shaft engaging portion 316 and the wheel coupling portion 318 may be one piece, or they may be separate parts coupled together. The compressible wheel 312 may be coupled to the wheel coupling portion 318 by an axle 322 extending through the center of the compressible wheel 312 to the wheel coupling portion 318, the compressible wheel 312 capable of freely rotating about the axle 322. As depicted, the wheel coupling portion 318 may support both ends of the axle 322. In another embodiment, the axle 322 may be coupled only at one end to the wheel coupling portion 318.

FIG. 3B is a front elevation view of the embodiment of FIG. 3A with the wheel 312 of the compressible wheel tip 310 compressed due to force applied down the shaft 320 of the walking aid. As depicted, the compressible material 313 may deform due to the force applied down the shaft 320 of the walking aid, enabling the wheel 312 to compress and restrict the wheel 312 from rolling. The wheel spokes 314 may guide deformation. Moreover, the wheel spokes 314, being formed of a material more rigid than the compressible material 313, may be configured to provide a firm base that restricts shifting or rolling when the compressible material 313 is compressed and deformed.

FIG. 4 is an exploded perspective view of one embodiment of a compressible wheel tip 410 and a shaft 420 of a walking aid. Similar to the embodiment previously discussed, the compressible wheel tip 410 may comprise a shaft engaging portion 416, a wheel coupling portion 418, and a compressible wheel 412 having a plurality of spokes 414 and a compressible material 413 between the spokes. The shaft engaging portion 416 and the wheel coupling portion 418 may be an integrated piece, as depicted in this exploded view, or they may be separate parts coupled together. The compressible wheel 412 may be coupled to the wheel coupling portion 418 by an axle 422 extending through the center of the compressible wheel 412 to the wheel coupling portion 418, such that the compressible wheel 412 may freely rotate about the axle 422.

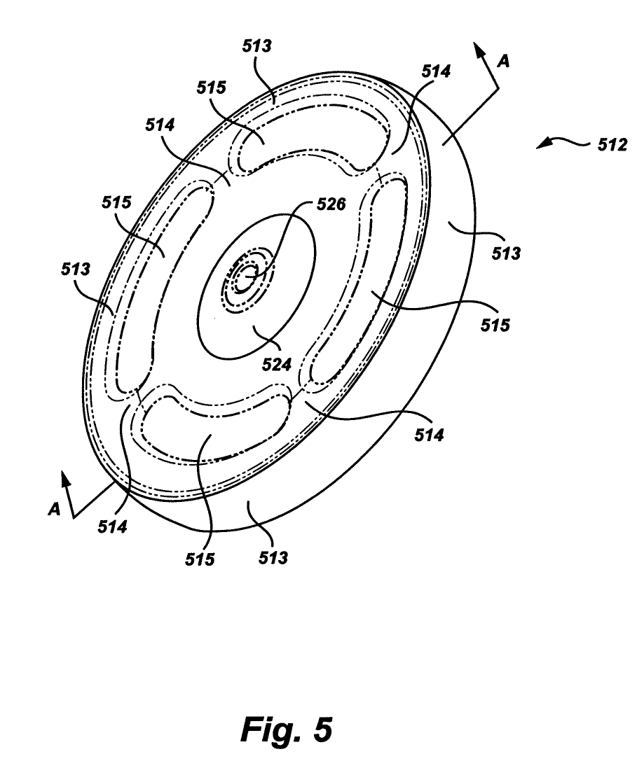

FIG. 5 is a perspective view of one embodiment of a compressible wheel 512. The wheel 512 comprises a plurality of spokes 514 and a compressible material 513 between, or spanning an arc between, the spokes 514. In this embodiment there are four spokes 514. The wheel 512 is another example of a configuration in which the compressible material 513 defines a void 515 that aids in deformation. A wheel configuration wherein the compressible material defines a void, as illustrated by wheel 512, makes possible forming the entire wheel 512, including the spokes 514, of the same material. The material could be any resilient, elastomeric material that would deform under an applied force. Although the spokes 514 may be formed of elastomeric material that deforms under an applied force, the elastomeric making up the compressible material 513 between the spokes would more readily deform under the same applied force due to the void 515. Moreover, the structure of the spokes 514 may be such that they better resist deformation. The compressible material 513 essentially deforms, or potentially even collapses, into the void 515 to expose the spokes 514. The arc between the spokes 515 flattens such that the spokes restrict shifting and rolling of the wheel 512.

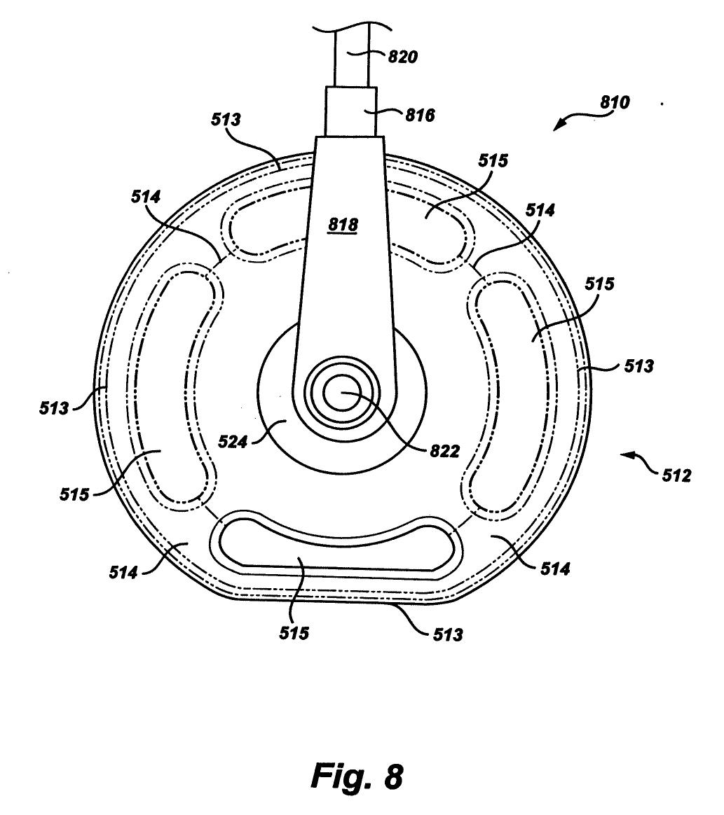

The wheel 512 of FIG. 5 may further comprise a hub 524. The hub 524 may join and/or provide additional support for the spoke. As depicted, the hub 524 may also form a hole 526 to receive an axle that couples the wheel to a compressible wheel tip as depicted in FIG. 8 below. The hub 524 may be formed of a different material than the compressible material 513 and spokes 514. For example, the hub 524 may be formed of a more rigid material, such as plastic or metal. In another embodiment, the hub 524 may be formed of the same material as the spokes 514 and compressible material 513. In still another embodiment, the compressible material 513, spokes 514, and hub 524 are a single integrated piece, each component being defined only by the structure of the wheel.

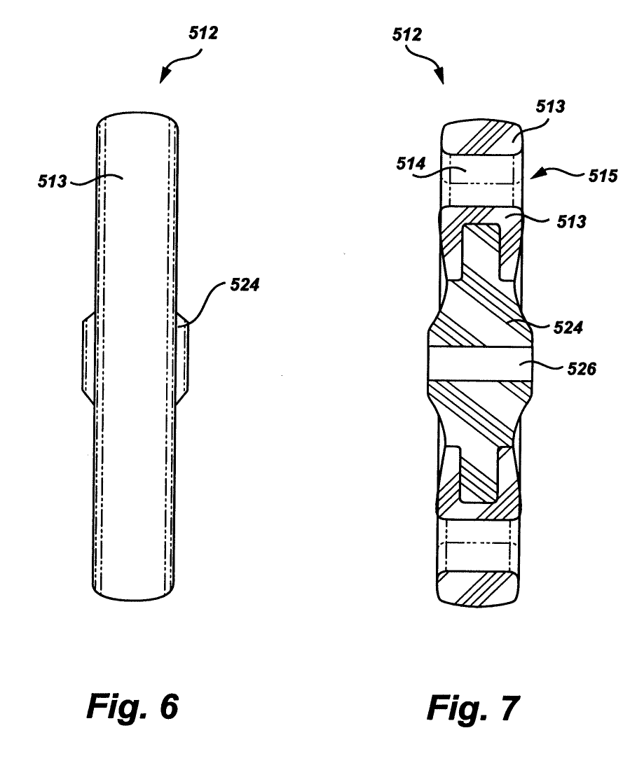

FIG. 6 is a front elevation view of the compressible wheel 512 of FIG. 5. The compressible material 513 between the spokes 514 may, at the perimeter of the wheel, be substantially integrated with spokes 514 such that the beginning and ending of the compressible material 513 is not readily identifiable. As depicted, the spokes 514 may not be identifiable from a front view of the wheel 512. The hub 524 may slightly protrude out from both sides of the wheel 512.

FIG. 7 is a front cross-sectional view of the compressible wheel 512 of FIG. 5. The cross-sectional view depicts the compressible material 513 defining a void 515, such that the portion of the compressible material 513 toward the perimeter of the wheel 512 can easily deform into the void 515. The spokes 514 may be integrated with the compressible material 513 as a single piece formed of the same material, and may partly define the void 515 as depicted in FIG. 7. The hub 524, as depicted in FIG. 7, may be formed of a different material, as indicated by the hash markings of the cross-section. As described, the hub 524 may be formed of a rigid material, such as plastic or metal, to provide support for the spokes and to facilitate coupling the wheel 512 to a walking aid. A hole 526 may be defined within the hub, the hole 526 configured to receive an axle for attaching the wheel 512 to a compressible wheel tip.

FIG. 8 is a side elevation view of one embodiment of a compressible wheel tip 810 attached to a shaft of a walking aid and comprising the compressible wheel 512 of FIG. 5, the wheel 512 of the compressible wheel tip 810 compressed due to force applied down the shaft 820 of the walking aid. The compressible wheel tip 810 comprises a shaft engaging portion 816, a wheel coupling portion 818, and the compressible wheel 512 of FIG. 5 having a plurality of spokes 514 and a compressible material 513 between, or spanning an arc between, the spokes 514. The compressible wheel 512 may be coupled to the wheel coupling portion 818 by an axle 822 extending through the center of the compressible wheel 812 to the wheel coupling portion 818, enabling the compressible wheel 512 to freely rotate about the axle 822.

The compressible material 513 is formed of an elastomeric material that is shown deformed under a force applied down the shaft 820 of the walking aid. The compressible material 513 forms an void 515. When a force is applied down the shaft 820 the compressible material 513 in contact with the ground deforms into the corresponding void 515. The arc between the spokes 514 closest to the ground flattens to allow those spokes 514 to simultaneously engage the ground and restrict shifting and rolling of the wheel 512.

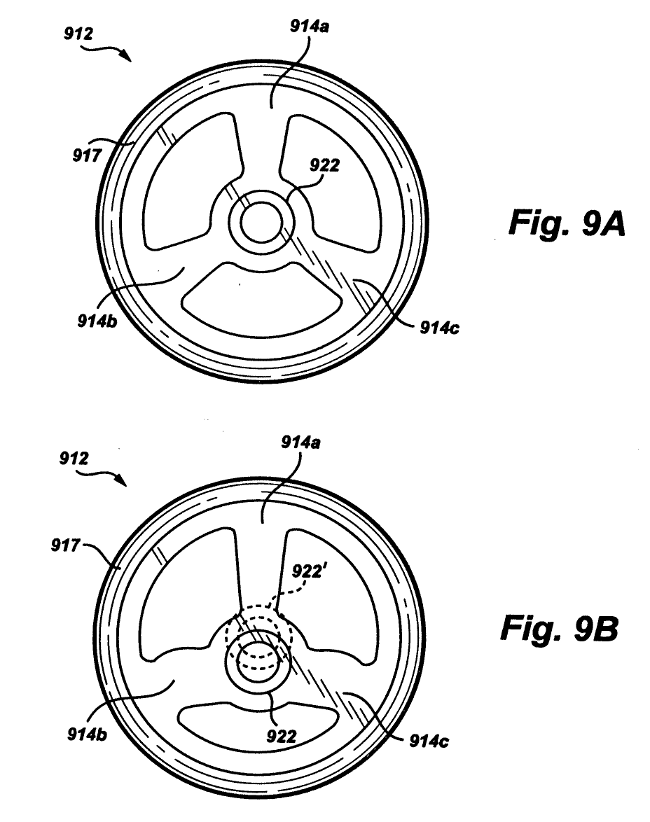

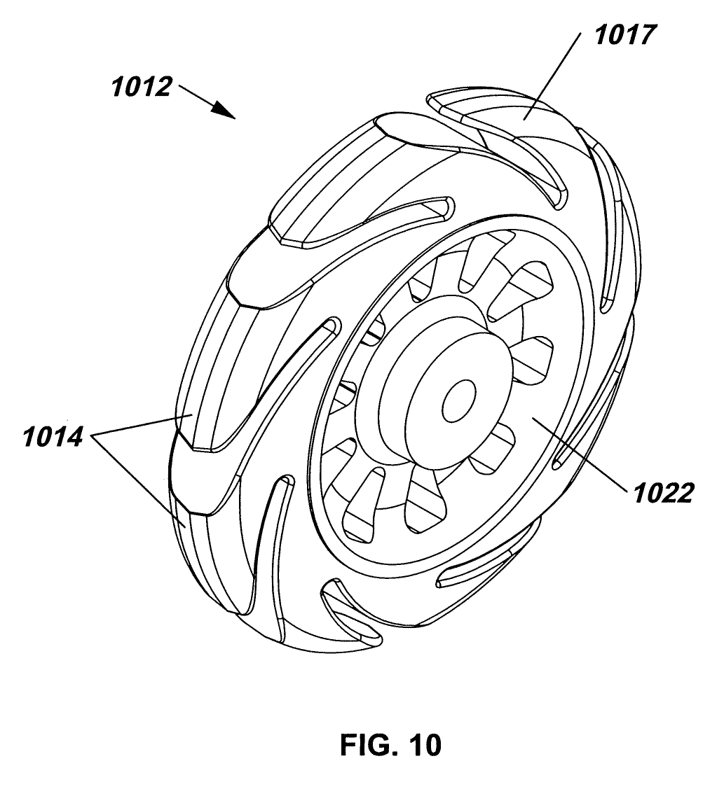

FIG. 9A is a side elevation view of another embodiment of a compressible wheel 912 in an uncompressed state. The compressible wheel 912 has a rigid outer rim 917, a hub 922, and a plurality of flexible spokes 914a, 914b, 914c (designated collectively as spokes 914) positioned between the hub 922 and the outer rim 917. The outer rim 912 has a round shape like a wheel and is formed of a rigid material, such as plastic or metal, to retain the round shape under pressure. In this embodiment, the outer rim 912 does not substantially deform under pressure applied down a shaft of a walking aid.

The hub 922 may also have a round shape like the outer rim, but is smaller. The hub 922 is at the center of the spokes at the point of intersection between the plurality of spokes 914. The hub 922 provides an axis of rotation for the compressible wheel 922, and thus is configured to couple the wheel 912 to a wheel coupling portion (not depicted). The hub 922 can be formed of a rigid material similar to the outer rim 917, so as to retain its shape under pressure applied to the wheel 912 down the shaft of a walking aid. The rigid material of the hub 922 also reduces tearing or breakage of the hub 922 or flexible spokes 914 as the wheel 912 compresses.

In the embodiment of FIG. 9A, the compressible wheel 912 has three flexible spokes 914a, 914b, 914c. Alternative configurations may include a different number of spokes. The spokes 914 are formed of a compressible material, such as plastic, that deforms when pressure is applied and returns to its initial state when the pressure is released. The compressible material may comprise a resilient, elastomeric material adapted to deform with applied force and to return to its original shape when the force is removed or sufficiently minimized. Optionally, the compressible material may be a thermoplastic material. When a force is applied down the shaft of a walking aid (not shown) to which the compressible wheel 912 may be coupled, the compressible material of the spokes 914 compresses and deforms.

FIG. 9B is a side elevation view of the compressible wheel 912 of FIG. 9A in a compressed state due to force applied to the wheel 912 down the shaft of a walking aid (not shown) to which the wheel may be coupled. As shown in FIG. 9B, the compressible material of the spokes 914 may deform when a force applied down the shaft of the walking aid reaches a threshold level. As the spokes 914 deform, rolling of the wheel 912 is restricted.

The force applied down the shaft is exerted on the hub 922, because the hub 922 couples to a wheel coupling portion to couple the wheel to the shaft. Accordingly, the force exerted on the hub 922 causes spoke 914a to stretch, and spokes 914b and 914c to compress. The deformation of the spokes 914 allows the hub 922 to shift, or relocate, downward as depicted in FIG. 9B. The position of the hub 922 in the uncompressed state is indicated in a broken outline of the hub 922′. As illustrated, the position of the hub 922 in the compressed state is lower and not in the center of the outer rim. The axis of rotation, in this case the hub 922, is no longer concentric to the rim. In this manner, a breaking action is produced and the compressible wheel 912 is restricted from rolling. When the wheel 912 is restricted from rolling properly, it provides a more stable base when the user is supporting his weight on the walking aid as described above.

The relocation of the hub 922 under an applied force can restrict the compressible wheel 912 from rolling in various ways. By way of example, and not limitation, shifting of the hub 922 downward causes the axis of rotation to be displaced from the center of the wheel 912. Accordingly, the rolling action of the wheel 912 is not symmetrical which creates frictional forces that cause a breaking action. The effect is similar to a flat tire on a car, where the axis of rotation is also lower than the central point of the circumference. The breaking action restricts the wheel 912 from rolling.

In an alternative embodiment, the shifting of the hub 922 downward causes the position of the shaft of the walking aid, and the position of a wheel coupling portion connected to the shaft, to shift lower relative to the outer rim 917 of the compressible wheel 912. The shift of position of the shaft and/or wheel coupling portion relative to the outer rim 917 can cause the rigid outer rim 917 to contact or abut against the shaft and/or wheel coupling portion. Contact of the rigid outer rim 917 with the shaft and/or wheel coupling portion creates frictional forces that enable the shaft and/or wheel coupling portion to restrict movement and/or rolling of the compressible wheel and produce a breaking action. Furthermore, the outer rim 917 can be pinned between the ground and the shaft and/or wheel coupling portion, thereby producing a breaking action that restricts rolling of the wheel.

FIG. 10 is a perspective view of yet another embodiment of a compressible wheel 1012 in an uncompressed state. The compressible wheel 1012 has a flexible outer periphery 1017, which comprises a plurality of deformable projections 1014 disposed along the outer periphery 1017. The compressible wheel 1012 may also include a rigid hub 1022. The hub 1022 provides an axis of rotation for the compressible wheel 1012, and thus is configured to couple the wheel 1012 to a wheel coupling portion (not depicted). The hub 1022 can be formed of a rigid material so as to retain its shape under pressure applied to the wheel 1012 down the shaft of a walking aid.

The deformable projections 1014 along the outer periphery 1017 are configured to deform when pressure is applied and returns to its initial state when the pressure is released. The compressible material may comprise a resilient material, such as polyurethane, which adapted to deform with applied force and to return to its original shape when the force is removed or sufficiently minimized. This deformation of the wheel 1012 creates a breaking action making it more difficult for the wheel 1012 to continue rolling.

The shaft engaging portions and hubs disclosed herein are examples of means for engaging a shaft of a walking aid. Furthermore, the wheel coupling portions disclosed are examples of means for engaging a compressible wheel.

The spokes, spoke configurations and deformable portions of the compressible wheels disclosed herein are examples of means for restricting movement of a compressible wheel. The compressible and deformable material disclosed are examples of a means for compressing and deforming under an applied force. The compressible material defining a void as disclosed herein is also an example of a means for compressing and deforming under an applied force.

While specific embodiments of walking aids and compressible wheel tips for walking aids have been illustrated and described, it is to be understood that the invention claimed hereinafter is not limited to the precise configuration and components disclosed. Various modifications, changes, and variations apparent to those of skill in the art may be made in the arrangement, operation, and details of the apparatus disclosed.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art that changes may be made to the details of the above-described embodiments without departing from the underlying principles of the invention as claimed hereinafter. In other words, various modifications and improvements of the embodiments specifically disclosed in the description above are within the scope of the appended claims. Note that elements recited in means-plus-function format are intended to be construed in accordance with 35 U.S.C. §112 ¶6.

What is claimed is:

1. A walking aid apparatus, comprising:
a walking aid configured to provide support to a user who applies pressure thereon, the walking aid comprising:
a handle by which a user can grasp the walking aid; and
a shaft extending from the handle toward the ground, the shaft having a handle end portion and a tip end portion; and
a compressible wheel tip coupled to one or more shafts of the walking aid, the wheel tip comprising:
a shaft-engaging portion for engaging the shaft of the walking aid;
a compressible wheel configured to roll when the user is not applying downward pressure to the walking aid and a portion of the compressible wheel configured to compress and deform, to restrict the wheel from rolling, when sufficient pressure is applied by the user down the shaft of the walking aid; and
a wheel coupling portion to couple to the compressible wheel, the wheel coupling portion attached to the shaft engaging portion.

2. The walking aid apparatus of claim 1, wherein the wheel coupling portion is rotatably coupled to the shaft engaging portion.

3. The walking aid apparatus of claim 1, wherein the wheel coupling portion comprises an axle about which the compressible wheel rotates.

4. The walking aid apparatus of claim 1, wherein the compressible wheel comprises:
one or more spokes;
a hub configured to support the one or more spokes and to couple the wheel to the wheel coupling portion; and
a compressible material forming an arcuate perimeter between the spokes,
wherein the compressible material is configured to compress under an applied force and the one or more spokes are formed of a material more rigid than the compressible material.

5. The walking aid apparatus of claim 4, wherein the compressible material of the compressible wheel is an elastomeric material.

6. The walking aid apparatus of claim 4, wherein the one or more spokes of the compressible wheel are formed of rigid plastic.

7. The walking aid apparatus of claim 4, wherein the one or more spokes of the compressible wheel are formed of metal.

8. The walking aid apparatus of claim 4, wherein the one or more spokes of the compressible wheel are formed of the same material as the compressible material and structured to resist deformation to a greater degree than the compressible material.

9. The walking aid apparatus of claim 4, wherein the compressible material of the compressible wheel forms a shape of a wheel around the outer perimeter of the one or more spokes.

10. The walking aid apparatus of claim 4, wherein the spokes of the compressible wheel are spaced such that the arcuate perimeter formed by the compressible material is compressible between the one or more spokes upon receiving a sufficient downward force.

11. The walking aid apparatus of claim 4, wherein the compressible material of the compressible wheel defines a void into which the compressible material can be deflected to further aid in compressibility.

12. The walking aid apparatus of claim 1, wherein the compressible wheel comprises:
an outer rim to provide a round shape to the compressible wheel;
a hub to couple the compressible wheel to the wheel coupling portion; and
one or more spokes between the outer rim and the hub, the one or more spokes formed of compressible material, wherein the compressible material of the one or more spokes is less rigid than the outer rim such that when sufficient pressure is applied by the user to the compressible wheel down the shaft of the walking aid, the spokes deform and restrict rolling of the compressible wheel.

13. A compressible wheel tip for a walking aid comprising:
a shaft-engaging member configured to engage a shaft of a walking aid;
a compressible wheel configured to roll when the user is not applying downward pressure to the walking aid and configured to compress and deform to restrict the wheel tip from rolling when sufficient pressure is applied by the user down the shaft of the walking aid; and
a wheel coupling portion to couple to the compressible wheel, the wheel coupling portion attached to the shaft engaging member.

14. The compressible wheel tip of claim 13, wherein the tip is removable from the shaft of the walking aid.

15. The compressible wheel tip of claim 13, wherein the wheel engaging member is rotatably coupled to the shaft engaging member.

16. The compressible wheel tip of claim 13, wherein the compressible wheel comprises:
one or more spokes;
a compressible material forming an arcuate perimeter between the one or more spokes and providing a round shape to the wheel, the compressible material being less rigid than the one or more spokes; and
a hub configured to support the one or more spokes and to couple the wheel to the wheel coupling portion.

17. The compressible wheel tip of claim 16, wherein the compressible material comprises an elastomeric material.

18. The compressible wheel tip of claim 16, wherein the one or more spokes of the compressible wheel are formed of the same material as the compressible material and structured to resist deformation to a greater degree than the compressible material.

19. The compressible wheel tip of claim 16, wherein the compressible material of the compressible wheel defines a void into which the compressible material can be deflected to further aid in compressibility.

20. The compressible wheel tip of claim 13, wherein the compressible wheel comprises:
an outer rim formed of a rigid material, the outer rim to provide a round shape to the compressible wheel;
a hub to couple the compressible wheel to the wheel coupling portion; and
one or more spokes between the outer rim and the hub, the one or more spokes formed of compressible material, wherein the compressible material of the one or more spokes is less rigid than the outer rim such that when sufficient pressure is applied by the user to the compressible wheel down the shaft of the walking aid, the spokes compress and deform to restrict rolling of the compressible wheel.

21. The compressible wheel tip of claim 20, wherein the outer rim of the compressible wheel is configured to contact the wheel coupling portion when sufficient pressure is applied by the user down the shaft of the walking aid to deform the one or more spokes, whereby the contact of the outer rim with the wheel coupling portion restricts rolling of the compressible wheel.

22. A compressible wheel tip for a walking aid comprising:
means for engaging a shaft of a walking aid;
a compressible wheel configured to roll when the user is not applying downward pressure to the walking aid and configured to compress and deform to restrict rolling when sufficient pressure is applied by the user down the shaft of the walking aid, the compressible wheel comprising:
means for restricting movement of the compressible wheel; and
means for compressing and deforming under an applied force, the compressing means forming an arcuate perimeter between the restricting means to define a wheel shape; and
means for engaging the compressible wheel, the wheel engaging means coupled to the shaft engaging means.

23. The compressible wheel tip of claim 22, wherein the wheel engaging means is rotatably coupled to the shaft engaging means.
